(19) United States
(12) Patent Application Publication
(10) Pub. No.: US 2024/0372191 A1
(43) Pub. Date: Nov. 7, 2024

(54) Battery Tray Made of Plastic, Comprising an Insertion Part, Tool and Method for Producing a Battery Tray, Traction Battery and Motor Vehicle

(71) Applicant: Kautex Textron GmbH & Co. KG, Bonn (DE)

(72) Inventors: Felix Tischer, Hammerstein (DE); Jonatan Schdanow, Swisttal (DE); Georg Enkirch, Salz (DE); Nicolay Bergmann, Aachen (DE); Timm Heidemeyer, Köln (DE); Fabian Siggia, Köln (DE); Roman Bouffier, Königswinter (DE)

(21) Appl. No.: 18/688,552

(22) PCT Filed: Aug. 11, 2022
(86) PCT No.: PCT/EP2022/072605

§ 371 Date: Mar. 1, 2024

(30) Foreign Application Priority Data
Sep. 6, 2021 (DE) 10 2021 123 003.9

(51) Int. Cl. H01M 50/207; B29C 45/14; B29L 31/00; H01M 10/04; H01M 50/224; H01M 50/244; H01M 50/249

(52) U.S. Cl. CPC H01M 50/207; B29C 45/14065; H01M 10/0404; H01M 50/224; H01M 50/244; H01M 50/249; B29C 2045/14163; B29L 2031/7146

(57) ABSTRACT

A battery shell, in particular a battery shell of a traction battery, wherein the battery shell has a base and at least four side walls, wherein the battery shell has an inner side and an outer side, wherein the battery shell is formed in hybrid design from an insertion part and a molding compound. The invention also relates to a traction battery comprising the same battery shell and a motor vehicle comprising the same battery shell. Furthermore, the invention relates to a tool for producing this battery shell and a method for producing the battery shell.

This patent application claims the priority of the German patent application 10 2021 123 003.9, the disclosure of which is herewith explicitly referenced.

The invention relates to a battery shell made of plastic comprising an insertion part, a tool and a method for producing a battery shell, a traction battery and a motor vehicle.

In particular, the invention relates to a battery shell, in particular a battery shell of a traction battery, wherein the battery shell has a base and at least four side walls, wherein the battery shell has an inner side and an outer side, wherein the battery shell is formed in hybrid design from an insertion part and a molding compound.

The demands on the geometric complexity and the structural-mechanical properties of battery shells, in particular battery shells for motor vehicles, are constantly increasing. At the same time, the objective is to reduce the cost and weight of battery shells.

The object of the invention is that of providing an improvement over or an alternative to the prior art.

According to a first aspect of the invention, the object is achieved by a battery shell, in particular a battery shell of a traction battery, wherein the battery shell has a base and at least four side walls, wherein the battery shell has an inner side and an outer side, wherein the battery shell has a hybrid design and is formed from an insertion part and a molding compound, wherein the battery shell has at least one indentation, preferably two indentations and particularly preferably more than two indentations, wherein one indentation extends in a region of the battery shell formed by the molding compound, wherein one indentation has a location corresponding to the insertion part and wherein a distance from the corresponding location of the indentation to the insertion part is less than or equal to 2 mm, preferably less than or equal to 1 mm and particularly preferably less than or equal to 0.5 mm.

In this regard, the following is explained conceptually:

It is first expressly noted that in the context of the present patent application, indefinite articles and numbers such as “one,” “two,” etc. should generally be understood as being “at least” statements, i.e. as “at least one . . . ,” “at least two . . . ,” etc., unless it is clear from the relevant context or it is obvious or technically compelling to a person skilled in the art that only “exactly one . . . ,” “exactly two . . . ,” etc. can be meant.

In the context of the present patent application, the expression “in particular” should always be understood as introducing an optional, preferred feature. The expression should not be understood to mean “specifically” or “namely.”

A “battery shell” is understood to mean a housing part of a battery, in particular of a traction battery.

In particular, a battery shell for receiving components of a battery is configured and accordingly has a receiving space for receiving components so that they can be protected by the battery shell from external influences and/or can be fastened at least indirectly in the battery shell.

Preferably, a battery shell is understood to mean a lower battery shell or an upper battery shell, the lower battery shell and the upper battery shell preferably jointly producing the essential components of the housing of a traction battery.

In particular, a battery shell has a “base” and, in the preferred case of a traction battery with a substantially rectangular outline, at least four “side walls”.

The base and side walls of the battery shell form the receiving volume of a battery shell, wherein the receiving volume of the battery shell describes the “inner side” of the battery shell.

Starting from the receiving volume of the battery shell, the “outer side” of the battery shell is located on the side of the base facing away from the receiving volume and the side walls.

A “hybrid design” is understood to mean a design of battery shells in which different components with to some extent different properties are combined to form a battery shell.

Among other things, it should be considered that an insertion part as a solid body having a higher tensile strength than a molding compound is connected to the molding compound to form a battery shell in hybrid design. Due to its high degree of geometric variability, the molding compound can enable the battery shell to achieve almost unlimited geometric complexity. Similarly, the high-strength insertion part can, in contrast to the molding compound, be used to achieve a battery shell with excellent structural-mechanical properties.

The hybrid design of a battery shell can improve the manifestations of properties of the battery shell as compared to the sole use of a molding compound.

An “insertion part” is understood to mean a solid body that can be introduced into a battery shell to stiffen the battery shell, in particular for local stiffening. In other words, an insertion part can be understood to mean a stiffening element and/or a local stiffening means.

Preferably, an insertion part has a higher tensile strength than a consolidated molding compound.

Preferably, an insertion part is a semi-finished product, in particular a semi-finished product that extends at least in some regions with a constant cross-section in the main direction of extension.

Preferably, an insertion part is formed from a metallic material. Alternatively, an insertion part is formed from plastic, in particular from a thermoplastic or a thermosetting plastic, wherein an insertion part formed from a plastic can also have a fiber volume content, as a result of which an additional stiffening of the insertion part can be achieved.

The term “insertion part” is understood to mean an insertion part that can remain rigid and dimensionally stable under the effect of the melt pressure and/or the temperature of the molding compound during the forming of the battery shell, i.e. it preferably does not deform plastically. In particular, an insertion part can be dimensionally stable during the handling of the insertion part, preferably during the insertion of the insertion part into the tool. The insertion part can deform during the forming of the battery shell, in particular due to the melt pressure during the flowing of the molding compound over the insertion part if it is an insertion part with a thermoplastic matrix.

Preferably, an insertion part is dimensionally stable, in particular an insertion part consisting of a metal or an insertion part comprising a thermoset is preferably dimensionally stable. A dimensionally stable insertion part can be understood to mean a structurally stable insertion part.

Preferably, an insertion part in a battery shell has a flatness tolerance in accordance with DIN ISO 1101 with a tolerance range of less than or equal to 4 mm, preferably with a tolerance range of less than or equal to 2 mm and particularly preferably with a tolerance range of less than or equal to 1 mm.

It is should be expressly noted that an insertion part comprising a thermoplastic material can only be dimensionally stable in its core up until its melting temperature is reached, so that, in the case of an insertion part comprising a thermoplastic material, it can be provided not to heat it up to melting temperature in the core before or during the forming of the battery shell.

The use of an insertion part comprising a thermoplastic material is thus not fundamentally different from the use of a thermosetting or metallic insertion part, in particular since an insertion part can remain dimensionally stable even upon insertion into the tool and can therefore also be placed upright, for example. Preferably, an insertion part remains dimensionally stable even under the influence of the melt pressure and the temperature of the molding compound.

The use of an insertion part for the battery shell proposed here can be demonstrated in the micrograph of a cross-section of the battery shell intersecting the insertion part. Preferably, an insertion part is not plastically deformed. However, in the case of an insertion part comprising a thermoplastic material and a molding compound comprising a thermoplastic material, according to a particularly preferred embodiment, a bonded connection can be achieved between the insertion part and the molding compound. It is expressly noted here that a bonded connection is not contraindicative of using an insertion part.

It should be considered here that, among other things, an insertion part with a thermoplastic base material is heated before insertion into the article cavity, in particular to a temperature that is slightly below the melting temperature of the base material, in particular to a temperature of more than or equal to 5° C. below the melting temperature of the thermoplastic base material, and the molding compound, which also comprises a thermoplastic suitable for a bonded connection as the base material, heats the surface of the insertion part in such a way that a bonded connection can be formed between the insertion part and the molding compound.

In particular, an insertion part does not mean an organic sheet heated above the melting temperature, since an organic sheet heated above the melting temperature can form folds and/or bulges due to the temperatures and forces acting on the organic sheet during the forming of a battery shell, as a result of which an organic sheet cannot be introduced into a battery shell comprising a molding compound in a reproducible and/or load-path-compatible manner, in particular not using an injection-molding process or a compression-molding process.

For a molding compound, a thermoplastic material or a thermosetting material which is optionally mixed with a fiber material, in particular glass fiber, carbon fiber, aramid fiber or the like, should be considered.

Preferably, the molding compound, in particular if the molding compound is a polyamide, has fibers with a length of less than or equal to 15 mm, preferably fibers with a length of less than or equal to 12 mm and particularly preferably fibers with a length of less than or equal to 10 mm.

Expediently, the molding compound, in particular if the molding compound is a polypropylene, has fibers with a length of less than or equal to 35 mm, preferably fibers with a length of less than or equal to 30 mm and particularly preferably fibers with a length of less than or equal to 25 mm.

Preferably, the molding compound, in particular if the molding compound is a thermosetting SMC (sheet molding compound), has fibers with a length of less than or equal to 65 mm, preferably fibers with a length of less than or equal to 57 mm and particularly preferably fibers with a length of less than or equal to 50 mm. Further preferably, the molding compound, in particular if the molding compound is a thermosetting SMC, has fibers with a length of more than or equal to 8 mm, preferably fibers with a length of more than or equal to 10 mm and particularly preferably fibers with a length of more than or equal to 12 mm.

An “indentation” is a hollow shape in the relief of the surface area of the battery shell. Preferably, an indentation is a concave and/or convex depression in the surface area of the battery shell; preferably, an indentation can have a plurality of spatial curvatures. According to a preferred embodiment, the geometry of an indentation corresponds to a segment of a sphere.

In the region of the indentation, the material thickness of the molding compound between the surface area of the battery shell and the insertion part decreases; in particular, the material thickness of the molding compound can also drop locally to 0 mm.

In other words, an indentation can be understood to mean a local taper in the material thickness of the molding compound in relation to the insertion part.

Preferably, an indentation has a longitudinal extension that corresponds to at least three times a transverse extension of the same indentation and preferably runs transversely to the preferred direction of designated continuous fibers in a designated insertion part.

An indentation in the battery shell corresponds to an elevation in the article cavity of the tool for forming the battery shell. In this connection, an indentation can serve as a support and as a means of reproducibly positioning the insertion part within the battery shell, which can ensure that the insertion part remains in place when the compression molding compound is flowing over it.

Among other things, an indentation is used for quality control of a produced battery shell, since the positioning of the insertion part in the battery shell can be checked by means of one or more indentations.

A “distance” is understood to mean a distance between the insertion part and the surface area of the battery shell, particularly in the region of an indentation. Preferably, the distance from the corresponding location of the indentation to the insertion part is less than or equal to 0.1 mm and particularly preferably equal to 0 mm.

Demands for a resource-optimized battery shell are resulting in high requirements for the geometric complexity and the structural-mechanical properties of the battery shell.

Specifically, a battery shell that has a positive-locking and/or bonded connection between at least one insertion part and the molding compound is proposed here. The insertion part advantageously makes possible a local stiffening of the battery shell, while the molding compound makes possible the production of a geometrically complex shape.

The use of an insertion part also enables a reproducible positioning of the insertion part within the battery shell, since an insertion part can also be reproducibly positioned in a tool for producing a battery shell, in particular with respect to the molding compound flowing during the forming of the battery shell. A reproducible local stiffening of the battery shell can thus be achieved as well, preferably a load-path-compatible, reproducible stiffening of the battery shell.

It is thus proposed here, among other things, to introduce an insertion part into a battery shell for stiffening instead of or in addition to an organic sheet heated above the melting temperature, since said sheet tends to deform under the effect of the temperature of the molding compound and the melting pressure of the molding compound in the tool, wherein folds and/or bulges can be formed, as a result of which the local rigidity of the battery shell can be significantly influenced. In other words, an insertion part prevents the formation of folds and/or the formation of bulges in a local stiffening measure and thus a reduction in the overall rigidity of the component. In addition, in some cases the surface quality of the battery shell can be improved, because no continuous fibers introduced for stiffening are pressed against the surface of the battery shell by the molding compound that is flowing over it.

Through the use of an insertion part, a thermally induced expansion of the local stiffening means can also be reduced or prevented.

In other words, the use of an insertion part can reduce or prevent a change in position of a local stiffening measure in the tool, in particular during the forming of the battery shell and/or by suitable design of the tool, due to molding compound flowing over it.

It should be expressly noted that a battery shell can also have a plurality of insertion parts, in particular two insertion parts, three insertion parts, four insertion parts, five insertion parts, six insertion parts, seven insertion parts, eight insertion parts, nine insertion parts and so on.

Preferably, a battery shell has a plurality of indentations, in particular a plurality of indentations arranged to correspond to one another, preferably a plurality of indentations arranged symmetrically in relation to the insertion part.

Advantageously, an indentation can be used to achieve reproducible and load-path-compatible positioning of an insertion part that locally reinforces the battery shell. Furthermore, an indentation can be used for quality control of the battery shell.

It should be expressly noted that the above values for the distance should not be understood as strict limits; rather, it should be possible to exceed or fall below them on an engineering scale without departing from the described aspect of the invention. In simple terms, the values are intended to provide a guide for the size of the distance range proposed here.

According to a particularly preferred embodiment, the insertion part is reinforced with continuous fibers.

In this regard, the following is explained conceptually:

An insertion part “reinforced with continuous fibers” is understood to mean an insertion part comprising a thermoplastic and/or a thermosetting material, wherein the insertion part has continuous fibers in the form of woven fabrics and/or in the form of unidirectional strips and/or in the form of non-woven fabrics.

Preferably, an insertion part reinforced with continuous fibers has unidirectional continuous fibers oriented predominantly in the longitudinal direction of the insertion part.

Due to an insertion part reinforced with continuous fibers, an insertion part with a comparatively high rigidity can be used, as a result of which the battery shell can also have a high degree of local rigidity.

A contact area between the insertion part and the molding compound is particularly preferably greater than or equal to 50% of the surface area of the insertion part, preferably greater than or equal to 55% of the surface area of the insertion part and particularly preferably greater than or equal to 60% of the surface area of the insertion part.

In this regard, the following is explained conceptually:

A “contact area” between an insertion part and the molding compound is understood to mean the surface area of the insertion part that is wetted by the molding compound.

Preferably, the surface area of the insertion part wetted by the molding compound is understood to mean the surface area of the insertion part at which the molding compound has a thickness of greater than or equal to 0.5 mm, preferably a thickness of greater than or equal to 1.0 mm and particularly preferably a thickness of greater than or equal to 1.5 mm.

Preferably, the “surface area of the insertion part” is understood to mean the surface area of the shell surface of the insertion part.

Further preferably, a contact area between the insertion part and the molding compound is greater than or equal to 65% of the surface area of the insertion part, preferably greater than or equal to 70% of the surface area of the insertion part and particularly preferably greater than or equal to 80% of the surface area of the insertion part. Further preferably, a contact area between the insertion part and the molding compound is greater than or equal to 85% of the surface area of the insertion part, preferably greater than or equal to 90% of the surface area of the insertion part and particularly preferably greater than or equal to 95% of the surface area of the insertion part.

For an insertion part with a complex geometry, in particular a geometry that differs from a rectangular cross-section, it is proposed that a contact area between the insertion part and the molding compound is greater than or equal to 25% of the surface area of the insertion part, preferably greater than or equal to 35% of the surface area of the insertion part and particularly preferably greater than or equal to 45% of the surface area of the insertion part.

A geometric boundary condition between the molding compound and the insertion part, which enables an improved connection between the molding compound and the insertion part, is proposed here.

With the value of the contact area proposed here, it is possible to achieve a positive-locking connection between the insertion part and the molding compound, at least in some regions. As a result, forces acting on the molding compound can advantageously interact with the insertion part, so that the local stiffening of the battery shell coming from the insertion part can be better utilized. As a result, higher mechanical loads, in particular tensile loads and/or flexural loads, can be transferred to the insertion part, as a result of which the structural-mechanical potential of the insertion part can be better exploited and the battery shell can be designed to better optimize resources.

Preferably, the value for the contact area can also be used to ensure that a partial area of the insertion part is completely wetted with the molding compound. Furthermore, it is preferable that at least a partial area of the insertion part can be enclosed on both sides by the molding compound, as a result of which a particularly advantageous positive-locking connection can be achieved.

Advantageously, it can also be achieved that the insertion part can be introduced practicably and/or expediently into a tool for forming the battery shell, since the insertion part is arranged in the tool at a distance from the edge of the tool cavity on at least two sides of a partial region of the designated insertion part prior to the designated flowing around with the molding compound, as a result of which, on the one hand, it can be handled well, in particular on both sides, and, on the other hand, in the case of a preheated insertion part, it does not lose its desired temperature difference to the tool wall so rapidly, since direct contact between the tool wall and the insertion part can be reduced or avoided to a large extent.

Furthermore, the value of the contact area proposed here means that any component distortion can be reduced by the at least partial positive locking, in particular the positive locking on both sides, between the insertion part and the molding compound, since the components consisting of the molding compound and the insertion part, which in some cases shrink unevenly, can be arranged symmetrically to one another.

Advantageously, by using the value for the contact area, it can also be achieved that the insertion part, at least with regard to its shell surface, can be completely enclosed by the molding compound, at least in some regions.

It is expressly noted that the effects resulting from the positive locking can also be combined with a bonded connection and an adhesive connection between the insertion part and the molding compound.

It should be expressly noted that the above values for the contact area should not be understood as strict limits; rather, it should be possible to exceed or fall below them on an engineering scale without departing from the described aspect of the invention. In simple terms, the values are intended to provide a guide for the size of the contact area range proposed here.

Preferably, a contact area between the insertion part and the molding compound is also less than or equal to 99.5% of the surface area of the insertion part, preferably less than or equal to 99% of the surface area of the insertion part and particularly preferably less than or equal to 97.5% of the surface area of the insertion part.

Advantageously, a contact area between the insertion part and the molding compound is less than or equal to 95% of the surface area of the insertion part, preferably less than or equal to 92.5% of the surface area of the insertion part and particularly preferably less than or equal to 90% of the surface area of the insertion part.

Due to the value of the contact area proposed here, a reproducible fixing of the insertion part within the designated tool for forming the battery shell and thus also a reproducible positioning of the insertion part within the battery shell can be achieved. In particular, the means for reproducibly positioning the insertion part in the tool, which preferably correspond to the contact area, can prevent a change in position of the insertion part in the tool during the molding of the battery shell, due to molding compound flowing over it, from being so pronounced that the insertion part reaches the wall of the article cavity in the region between corresponding means for reproducible positioning.

It should be expressly noted that the above values for the contact area should not be understood as strict limits; rather, it should be possible to exceed or fall below them on an engineering scale without departing from the described aspect of the invention. In simple terms, the values are intended to provide a guide for the size of the contact area range proposed here.

The insertion part is preferably produced using a pultrusion process.

In this regard, the following is explained conceptually:

“Pultrusion process” is understood to mean an automatable or automated continuous process for the production of insertion parts, in particular insertion parts reinforced with continuous fibers, which is preferably suitable for large-scale production.

This advantageously allows insertion parts to be reproducibly produced

for large-scale production with a very high degree of geometric and structural design freedom. In other words, the properties of an insertion part can be optimally adapted to the requirements of the battery shell.

By using an insertion part produced using the pultrusion process, an insertion part can have a complex geometry and preferably a homogeneous structure of continuous fibers. These properties can be verified in a profile section of the battery shell, so that an insertion part produced using the pultrusion process can also be verified by means of a profile section.

The battery try is optionally formed using an injection-molding process or a compression-molding process.

In this regard, the following is explained conceptually:

An “injection-molding process” is understood to mean a primary shaping process, in which the material to be processed, in particular plastics material, is liquefied by means of an injection-molding machine and injected under pressure into a mold, i.e., the injection mold. In the injection mold, the material returns to its solid state as a result of cooling and/or a cross-linking reaction and can be removed as a component part after the injection mold has been opened.

A “compression-molding process” is understood to mean a primary shaping process in which the molding compound is introduced into the cavity of an associated compression mold in a first step, with the compression mold being closed in a second step, in particular using a pressure piston. By the closure of the compression mold, the molding compound acquires the shape specified by the compression mold. The compression mold is preferably temperature-controlled.

In particular, a compression-molding process can also be understood as a direct compounding process (D-LFT), in which a fiber material is fed into an extruder, where it is impregnated with the already melted matrix polymer, in particular a thermoplastic material, and is transferred into an injection piston and is then introduced into the compression mold as a molding compound.

Advantageously, an established production process for the battery shell proposed here can thus be used, as a result of which costs can be saved and the process risk of the production process can be minimized.

At a location corresponding to the insertion part an indentation expediently runs in a straight line at least in some regions.

Among other things, an indentation that has the form of a groove, at least in some regions, should be considered. It should be particularly preferably considered that an indentation with the shape of a groove corresponds to a guide region within the article cavity of the tool for producing the battery shell, wherein an indentation within the battery shell makes possible a linear support of the insertion part on the guide region in the article cavity.

It should be preferably considered that the course, which is straight at least in regions, of the deepest point of the indentation ends at least on one side in the plane of the continuous surface area of the battery shell. As a result, notch stress in this region can be prevented or reduced.

Likewise expediently, an indentation has the form of a groove.

According to a preferred embodiment, an indentation at a location corresponding to the insertion part has, at least in some regions, a plane that runs parallel to a plane of the insertion part.

In this regard, the following is explained conceptually:

The term “parallel to a plane” is understood to mean that the plane of the indentation runs substantially parallel to the plane of the corresponding insertion part, wherein the normal vectors of the respective planes have, corresponding to the associated manufacturing tolerances and positioning tolerances, a difference angle of less than or equal to 5°, preferably a difference angle of less than or equal to 2°, more preferably a difference angle of less than or equal to 1° and particularly preferably a difference angle of less than or equal to 0.5°. Preferably, the planes even coincide.

Among other things, an indentation should be considered here which corresponds to a stop in an article cavity in a designated tool for producing the battery shell, wherein the stop is configured for reproducible positioning of the insertion part in the battery shell.

Optionally, an indentation opposite the base of the battery shell runs horizontally and/or vertically, at least in some regions.

Expediently, an indentation has a transverse extension, wherein the transverse extension has a width of more than or equal to 1 mm at its widest point and/or wherein the transverse extension has a width of less than or equal to 20 mm at its widest point.

In this regard, the following is explained conceptually:

A “transverse extension” of the indentation is understood to mean the extension of the indentation that the indentation has transversely to a direction of symmetry of the indentation.

Preferably, an indentation has a width of greater than or equal to 2 mm, preferably greater than or equal to 3 mm and particularly preferably greater than or equal to 5 mm.

Further preferably, an indentation has a width of less than or equal to 25 mm, preferably a width of less than or equal to 15 mm, and particularly preferably a width of less than or equal to 10 mm.

It should be preferably considered that an indentation merges continuously and/or continuously and differentiably into the immediately adjacent and at least partially flat surface area of the battery shell.

It should be expressly noted that the above values for the transverse extension should not be understood as strict limits; rather, it should be possible to exceed or fall below them on an engineering scale without departing from the described aspect of the invention. In simple terms, the values are intended to provide a guide for the size of the transverse extension range proposed here.

Preferably, an indentation encloses one edge of the insertion part at least in some regions, preferably two edges of the insertion part at least in some regions.

In this regard, the following is explained conceptually:

An “edge” is understood to mean a continuous but non-differentiable transition between two surfaces of the insertion part.

Among other things, an indentation is proposed here, which is provided for positioning the insertion part as a stop and/or as a support and/or as a guide, wherein the indentation corresponds to two, in particular with at least two and/or three surfaces of the insertion part.

Preferably, an indentation on the side opposite the insertion part of the region of the battery shell receiving the insertion part has a corresponding opposite indentation, preferably the opposite indentations are arranged symmetrically in relation to one another.

Among other things, a geometry of the battery shell is proposed here, which corresponds to a means for reproducibly positioning the insertion part within the article cavity and/or within the battery shell. Preferably, a geometry should be considered here that corresponds to a guide region within the article cavity.

Preferably, it should be considered that the opposite indentation is arranged opposite with respect to at least one axis of symmetry, preferably two axes of symmetry.

Furthermore, an opposite indentation can also be connected to the corresponding indentation in a contiguous manner, wherein preferably at least two edges of the insertion part are enclosed by the contiguous indentation.

Optionally, a first indentation on the side opposite the insertion part of the region of the battery shell receiving the insertion part has a second indentation, which is arranged offset to a position opposite the first indentation.

Among other things, an alternating arrangement of a plurality of indentations is proposed here.

Expediently, an insertion part is arranged in an inner stiffening means of the battery shell, in particular in a rib.

In this regard, the following is explained conceptually:

An “inner stiffening means” is understood to mean a geometric configuration of the battery shell on the inner side of the battery shell which is configured to stiffen the battery shell.

Preferably, an inner stiffening means is a rib. A rib is understood to mean a geometry exhibited in the interior of the battery shell and configured to stiffen the battery shell.

Preferably, a rib is a longitudinal rib, where a longitudinal rib extends in the longitudinal direction of the battery shell and is configured to increase at least one area moment of inertia, particularly preferably two area moments of inertia, of a cross section of the battery shell running normal to the longitudinal direction, so that the battery shell is stiffened.

Preferably, a rib is a transverse rib, wherein a transverse rib extends in the transverse direction of the battery shell and is configured to increase at least one area moment of inertia, particularly preferably two area moments of inertia, of a cross-section of the battery shell running normal to the transverse direction, so that the battery shell is stiffened.

Preferably, a rib is arranged such that it is configured as a spatial separation between two designated adjacent battery cells and/or battery modules. Particularly preferably, a battery module can be fastened to an inner stiffening means, further preferably a battery module is carried by an inner stiffening means.

An inner stiffening means preferably has at least one longitudinal rib and at least one transverse rib. Preferably, the at least one longitudinal rib and the at least one transverse rib are connected to one another.

As a result, it can be achieved that the insertion part can be introduced into the battery shell in a particularly advantageous load-path-compatible manner, wherein at the same time the available installation space, for example in a separating rib arranged between the designated battery modules, can be utilized.

An insertion part is also expediently arranged in an outer stiffening means of the battery shell.

In this regard, the following is explained conceptually:

An “outer stiffening means” is understood to mean a geometric configuration of the battery shell on the outer side of the battery shell and/or a material change of the battery shell which is configured to stiffen the battery shell.

An outer stiffening means is preferably configured to stiffen the base of the battery shell and/or at least one side wall of the battery shell.

Preferably, an outer stiffening means is intended to mean a profile of at least one side wall of the battery shell, wherein the profiling of the at least one profiled side wall of the battery shell increases at least one area moment of inertia of the at least one profiled side wall of the battery shell, particularly preferably two area moments of inertia of the at least one profiled side wall of the battery shell, relative to a side wall of a battery shell without profiling and with comparable wall thickness and comparable material composition.

During profiling, an I-profile, a U-profile, a T-profile, a Z-profile, an L-profile, a hollow profile, a profile cumulatively composed of the previously mentioned profiles or a different profiling are preferably to be considered.

It should be expressly noted that a profiling can be understood to mean any geometric change relative to a planar extension of at least one side wall and/or the base of the battery shell.

It should be expressly noted that the aspect of an outer stiffening means presented here is not limited to a stiffening of one side wall of the battery shell; rather, even two or more side walls of the battery shell, preferably all of the side walls of the battery shell, can have an outer stiffening.

It should be expressly noted that a side wall can represent a component of an outer stiffening means.

Advantageously, as a result an insertion part can be arranged as a local stiffening measure in a particularly advantageous region of the battery shell. In most applications, the outer stiffening means is used to fasten the battery shell to the designated motor vehicle, so that this alone places greater loads on the battery shell. In addition, a region of the battery shell that is exposed to high external loads in the event of a side pole impact can be stiffened in this way.

Optionally, the insertion part comprises a thermoplastic, a thermosetting or a metallic base material.

In this regard, the following is explained conceptually:

An insertion part can consist entirely of a homogeneous “base material” or have a reinforcement in addition to the base material, in particular in the form of glass fibers, carbon fibers, aramid fibers and/or basalt fibers.

A “thermoplastic base material” can be formed in a material-dependent temperature range, wherein this process is reversible and can be repeated as often as required by cooling and reheating to the molten state.

A “thermosetting base material” can no longer be deformed by heating or other measures once it has hardened.

Preferably, the molding compound has a thermoplastic or thermosetting base material.

A polyamide is preferably considered here, in particular a polyamide 6, a polyamide 6.6 or a polyamide 12. Furthermore, the molding compound can preferably comprise polypropylene or polycarbonate.

According to a particularly practical aspect, the insertion part has a chamfer.

A “chamfer” is a beveled surface on a first edge of the insertion part. A chamfer can have an angle of greater than or equal to 20°, preferably an angle of greater than or equal to 30°, further preferably an angle of greater than or equal to 40° and particularly preferably an angle of greater than or equal to 50°. A chamfer can have an angle of less than or equal to 70°, preferably an angle of less than or equal to 60°, more preferably an angle of less than or equal to 50° and particularly preferably an angle of less than or equal to 40°.

Preferably, the insertion part has a chamfer on the designated edge of the insertion part facing away from the article cavity and/or the surface area of the battery shell.

The chamfer can extend over a thickness of greater than or equal to 20% of the thickness of the insertion part, preferably over a thickness of greater than or equal to 40% of the thickness of the insertion part, further preferably over a thickness of greater than or equal to 60% of the thickness of the insertion part and particularly preferably over a thickness of greater than or equal to 80% of the thickness of the insertion part.

The beveled surface of the chamfer can coincide with a second edge, wherein the second edge is arranged adjacent to the first edge. As a result, the insertion part can end at least on one side in a sharp edge, wherein the sharp edge has an opening angle of less than or 70°, preferably an opening angle of less than or 50° and particularly preferably an opening angle of less than or 30°.

At the closing of the tool, the molding compound flows over the insertion part with a moving flow front, as a result of which the position of the insertion part can change or the structure of the insertion part can be damaged.

The chamfer can be configured to interact with a flow front of the molding compound during the forming of the battery shell, in particular by the specific design of the end of the insertion part that first comes into contact with the flow front, in particular by a chamfer on an edge of the insertion part. For example, an edge designated by the flow front of the molding compound for being flowed around at an angle can have a chamfer and thus a beveled surface. As a result, it can be achieved that the flow resistance acting on the molding compound from the insertion part can be reduced and/or smaller forces can be transferred from the molding compound to the insertion part, as a result of which any structural damage to the insertion part can be reduced or prevented. Furthermore, as a result it can be achieved that the compressive force transferred from the molding compound to the insertion part has a component that runs normal to the beveled surface. Among other things, this enables the insertion part to be pressed against the article cavity of the tool by the molding compound, as a result of which a reproducible arrangement of the insertion part in the battery shell can be achieved.

According to a second aspect of the invention, the object is achieved by a tool for producing a battery shell according to the first aspect of the invention, wherein the tool forms an article cavity, wherein the tool has a means for reproducibly positioning an insertion part within the article cavity, wherein the tool has a means for introducing a molding compound into the article cavity.

In this regard, the following is explained conceptually:

A “tool” is understood to mean a device for primary shaping, in particular

for primary shaping of a battery shell according to the first aspect of the invention from a molten molding compound.

A tool is preferably understood to mean an injection mold.

A tool is preferably understood to mean a compression tool.

A tool is preferably understood to mean a positive mold.

An “article cavity” is understood to mean the hollow space which is formed by a tool for forming regions of the component that is designated to be produced with the tool, in particular a battery shell.

A “means for inserting the molding compound into the article cavity” is understood to mean a device which is indirectly or directly assigned to the tool and is configured to introduce a molten molding compound into the tool.

Preferably, a means for inserting the molding compound into the article cavity is understood to mean a device which is configured to fill the article cavity of the tool and/or the tool cavity of the tool with a molten molding compound, in particular in connection with an injection mold and/or an injection-molding device.

Preferably, a means for inserting the molding compound into the article cavity is understood to mean a device by means of which a molten molding compound can be introduced, in particular can be inserted, into a previously opened tool, in particular in conjunction with a compression mold and/or a pressing device.

A “means for reproducible positioning” is understood to mean a holding means and/or a connecting means which is configured to position the insertion part in a reproducible position within the tool and thus also within the designated battery shell. Preferably, a means for reproducible positioning corresponds to a means for a reproducible statically determined positioning or a reproducible statically overdetermined positioning. Preferably, a means for reproducible positioning has a stop, preferably a plurality of stops, and/or a guide region, preferably a plurality of guide regions, and/or a spring-loaded clamping means, preferably a plurality of clamping means, and/or consists of any combination of these different means.

Here, a tool for producing a battery shell according to the first aspect of the invention is proposed.

It should be understood that the previously explained advantages of a battery shell according to the first aspect of the invention extend to a tool for producing a battery shell according to the first aspect of the invention.

Expediently, the tool has at least one stop, preferably at least two stops, wherein the stop is at least part of the means for reproducibly positioning the insertion part.

In this regard, the following is explained conceptually:

A “stop” is understood to mean a boundary on at least one side against which an insertion part can be placed during designated insertion into the tool and as a result of which the position of the insertion part within the article cavity can be designed to be reproducible.

Expediently, the tool has at least one guide region, preferably at least two guide regions, wherein one guide region is configured to guide the insertion part at least on one side, preferably to guide the insertion part on two sides of the insertion part corresponding to one another via the insertion part, wherein one guide region is at least part of the means for reproducibly positioning the insertion part.

In this regard, the following is explained conceptually:

A “guide region” is understood to mean a region in the boundary of the article cavity which is configured to guide an insertion part during designated insertion into the article cavity and/or during the forming of the battery shell and/or during demolding of the battery shell. As a result, a guide region can interact with respect to one or more surface areas of the insertion part and contribute to reproducibly positioning and/or aligning the insertion part within the article cavity.

Advantageously, it can be achieved by means of a guide region that the insertion part is automatically centered during designated insertion into the article cavity.

Preferably, a guide region is designed to correspond to an indentation in the battery shell.

Expediently, the means for reproducibly positioning the insertion part is spring-loaded.

Among other things, a spring-loaded clamping means should be considered here, which is designed to give the insertion part at least a degree of static determinacy and which, preferably after insertion of the insertion part into the article cavity, only makes possible relative movement between the article cavity and the insertion part during the demolding of the battery shell.

It should be expressly noted that the subject-matter of the second aspect can advantageously be combined with the subject-matter of the preceding aspect of the invention, both individually or cumulatively in any combination.

According to a third aspect of the invention, the object is achieved by a method for producing a battery shell according to the first aspect of the invention, by means of an injection-molding device or a compression-molding device with a tool forming an article cavity according to the second aspect of the invention, comprising a means for reproducibly positioning an insertion part within the article cavity and a means for introducing a molding compound into the article cavity, wherein the method for producing the battery shell comprises the following steps:
a) inserting the insertion part into the article cavity;
b) inserting the molding compound into the article cavity;
c) forming the battery shell;
d) demolding the battery shell.

Here, it is proposed to form a battery shell according to the first aspect of the invention by means of an injection-molding process and/or an extrusion-molding process.

The method proposed here facilitates the reproducible and/or load-path-compatible positioning of a local stiffening measure in the battery shell by using an insertion part.

The insertion part is a previously produced semi-finished product, which preferably has a higher strength than the molding compound used here and can therefore be used for local stiffening of the battery shell, while the molding compound introduced in the viscous state enables a high degree of geometric flexibility for the geometry of the battery shell.

In particular, the insertion part enables comparatively easy handling prior to and during insertion into the article cavity due to its structural stability. Furthermore, due to its structural stability, the insertion part can interact advantageously with a means for reproducibly positioning the insertion part in the article cavity, as a result of which it can also be achieved that the insertion part can assume a substantially defined and reproducible relative position in relation to the molding compound of the battery shell during the forming of the battery shell.

Preferably, an insertion part comprising a thermoplastic base material is heated prior to insertion into the article cavity, wherein the maximum temperature reached by the insertion part before insertion remains below the melting temperature of the thermoplastic material, in particular remains at least 5° C. below the melting temperature of the thermoplastic material. On the one hand, this can ensure that the insertion part remains in place and, on the other hand, when a molding compound containing a thermoplastic is used, a bonded connection can be created between the insertion part and the molding compound. In particular, it should be considered that the molding compound transfers a heat flow to the surface area of the insertion part when flowing over the heated insertion part, which makes possible a bonded connection between the insertion part and the molding compound.

It is evident that the advantages of a battery shell according to the first aspect of the invention extend to a method for producing a battery shell according to the first aspect of the invention.

It should be expressly noted that the subject-matter of the third aspect can advantageously be combined with the subject-matter of the preceding aspects of the invention, both individually and cumulatively in any combination.

According to a fourth aspect of the invention, the object is achieved by a traction battery, in particular a traction battery for a motor vehicle, comprising a battery shell according to the first aspect of the invention and/or a battery shell produced with a tool according to the second aspect of the invention and/or a battery shell produced with a method according to the third aspect of the invention.

In this regard, the following is explained conceptually:

A “motor vehicle” is understood to mean a vehicle driven by a motor. A motor vehicle is preferably not mounted on a rail or at least not permanently track-mounted.

It is evident that the advantages of a battery shell according to the first aspect of the invention, as described above, and/or a battery shell produced with a tool according to the second aspect of the invention, as described above, and/or a battery shell produced with a method according to the third aspect of the invention, as described above, extend directly to a traction battery comprising a battery shell according to the first aspect of the invention and/or a battery shell produced using a tool according to the second aspect of the invention and/or a battery shell produced using a method according to the third aspect of the invention.

It should be expressly noted that the subject-matter of the fourth aspect can advantageously be combined with the subject-matter of the preceding aspects of the invention, both individually and cumulatively in any combination.

According to a fifth aspect of the invention, the object is achieved by a motor vehicle comprising a battery shell according to the first aspect of the invention and/or a battery shell produced with a tool according to the second aspect of the invention and/or a battery shell produced with a method according to the third aspect of the invention.

It is evident that the advantages of a battery shell according to the first aspect of the invention as described above and/or a battery shell produced with a tool according to the second aspect of the invention as described above and/or a battery shell produced with a method according to the third aspect of the invention as described above extend directly to a motor vehicle comprising a battery shell according to the first aspect of the invention and/or a battery shell produced with a tool according to the second aspect of the invention and/or a battery shell produced with a method according to the third aspect of the invention.

It should be expressly noted that the subject-matter of the fifth aspect can advantageously be combined with the subject-matter of the preceding aspects of the invention, both individually and cumulatively in any combination.

Further advantages, details and features of the invention can be found below in the described embodiments. In the figures, in detail:

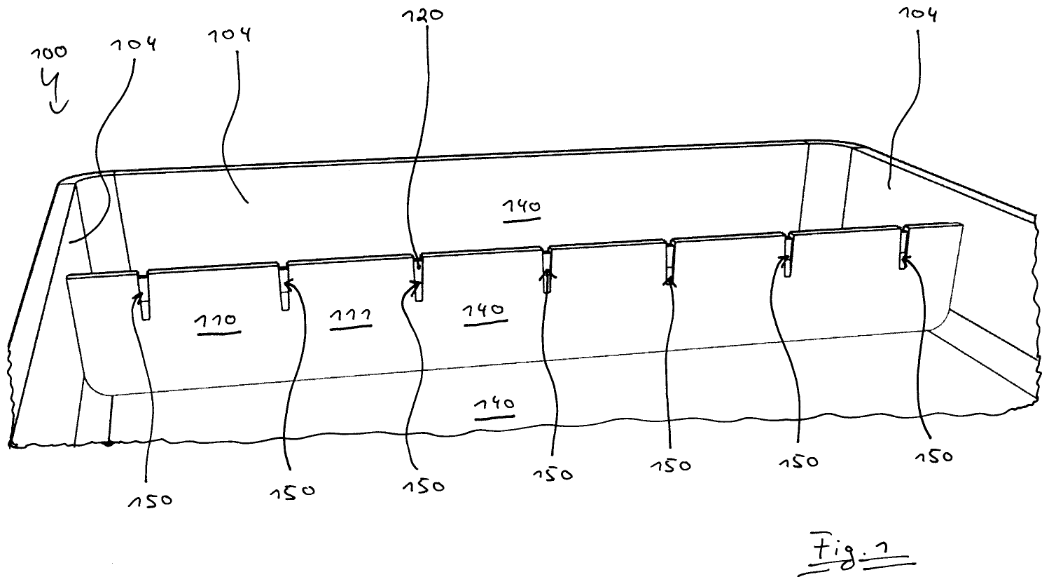

FIG. 1: schematically shows a detail of a first embodiment of a battery shell in perspective view;

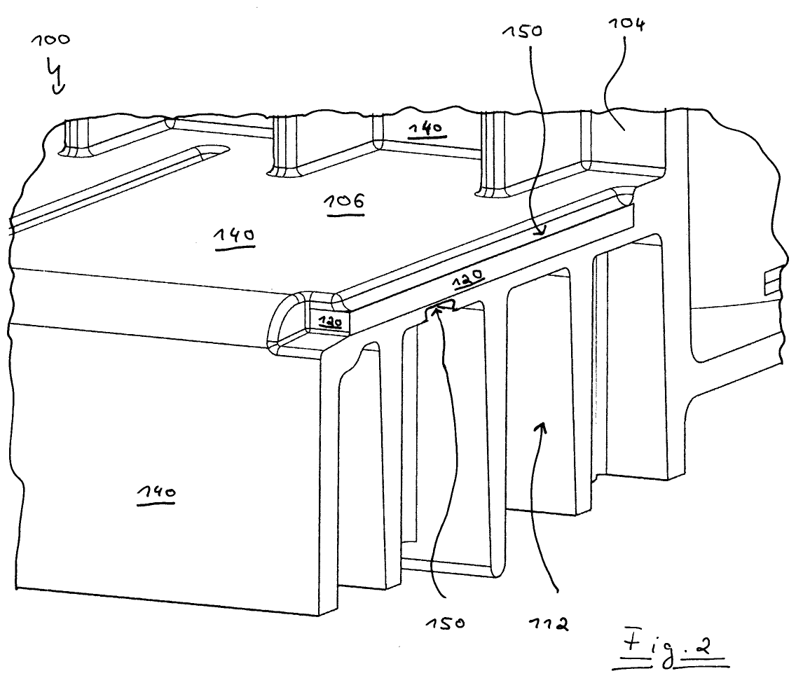

FIG. 2: schematically shows a detail of a second embodiment of a battery shell in perspective view, wherein the battery shell has a sectional view; and

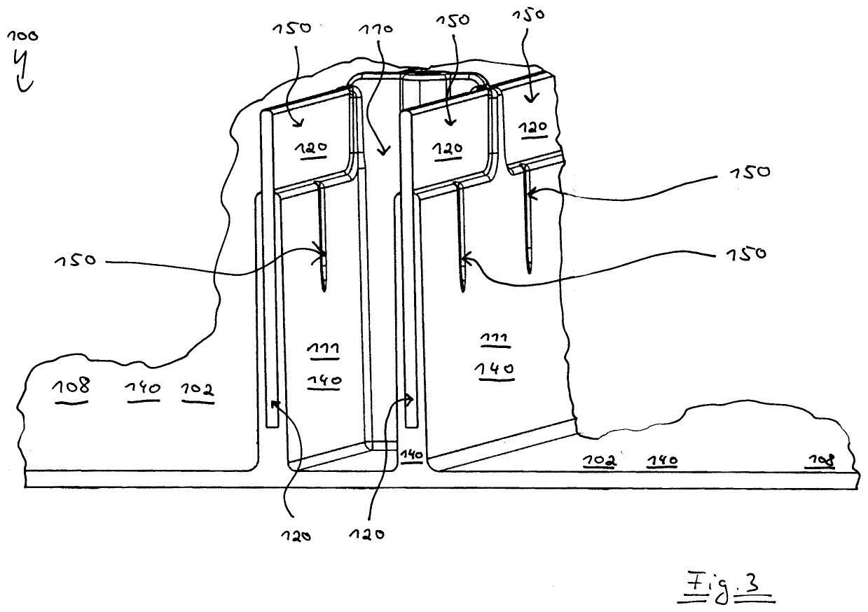

FIG. 3: schematically shows a detail of a third embodiment of a battery shell in perspective view, wherein the battery shell has a sectional view.

In the following description, the same reference signs denote the same components or features; in the interest of avoiding repetition, a description of a component made with reference to one drawing also applies to the other drawings. Furthermore, individual features that have been described in connection with one embodiment can also be used separately in other embodiments.

The detail of an embodiment of a battery shell 100 in FIG. 1 has a battery shell 100 consisting of a base 102 and at least one side wall 104, wherein the battery shell 100 has an inner side 108 and an outer side 106.

The battery shell 100 is of hybrid design and has an insertion part 120 in addition to the molding compound 140.

The battery shell 100 has an inner stiffening means 110, which is shaped in the form of a rib 111. The insertion part 120 is received in the battery shell 100 in the region of the inner stiffening means 110.

The battery shell 100 has a plurality of indentations 150, which can be used for quality control of the positioning of the insertion part 120 within the battery shell 100. In the region of the indentations 150, which enclose two edges (not designated) of the insertion part 120, the wall thickness of the molding compound 140 is 0 mm in some cases. In other words, the insertion part 120 is directly visible from the outside in regions of the indentations 150.

The insertion part 120 can have a chamfer. Preferably, the insertion part 120 has a chamfer that is configured to interact with a flow front of the molding compound 140 during the forming of the battery shell 100, wherein, in particular, a flow pressure of the molding compound 140 advantageously interacts with the chamfer during the forming of the battery shell 100. As a result, it can be achieved that the insertion part can be reproducibly pressed against an article cavity (not shown) of a tool (not shown) using the flow pressure of the molding compound 140, as a result of which, as a whole, a reproducible arrangement of the insertion part 120 in the battery shell 100 can be supported and/or the reproducibility of an arrangement of the insertion part 120 in the battery shell 100 can be improved.

The detail of an embodiment of a battery shell 100 in FIG. 2 shows an outer side 106 of the battery shell 100, wherein the battery shell 100 is shown cut in such a way that the outer stiffening means 112 is also cut.

The insertion part 120 is arranged in the region of the outer stiffening means 112.

The battery shell 100 has a plurality of indentations 150 in a region corresponding to the insertion part 120, through which the position of the insertion part 120 can be checked. On the flat upper side (not labeled) of the insertion part 120, the indentation 150 has the form of a groove.

On the end face of the insertion part 120, the indentation 150 has the form of a stop within the article cavity (not shown) of the tool (not shown) with which the battery shell 100 has been produced.

The detail of an embodiment of a battery shell 100 in FIG. 3 shows an inner side 108 of the battery shell, wherein the battery shell 100 is shown cut in such a way that the inner stiffening means 110 comprising two ribs 111 running in parallel is also cut.

Each rib 111 has a separate insertion part 120.

The battery shell 100 has indentations 150 in the region of the molding compound 140 in the regions corresponding to the respective insertion parts 120.

### LIST OF REFERENCE SIGNS

100 Battery shell
102 Base
104 Side wall
106 Outer side
108 Inner side
110 Inner stiffening means
111 Rib
112 Outer stiffening means
120 Insertion part
140 Molding compound
150 Indentation

1. A battery shell, in particular a battery shell of a traction battery, wherein the battery shell has a base and at least four side walls, wherein the battery shell has an inner side and an outer side,
wherein
the battery shell is formed in hybrid design from an insertion part and a molding compound,
wherein the battery shell has at least one indentation, wherein the at least one indentation extends in a region of the battery shell formed by the molding compound, wherein the at least one indentation has a location corresponding to the insertion part and wherein a distance from the corresponding location of the at least indentation to the insertion part is less than or equal to 2 mm.

2. The battery shell according to claim 1, wherein the insertion part is reinforced with continuous fibers.

3. The battery shell according to claim 1, wherein a contact area between the insertion part and the molding compound is greater than or equal to 50% of the surface area of the insertion part.

4. The battery shell according to claim 1, wherein a contact area between the insertion part and the molding compound is less than or equal to 99.5% of the surface area of the insertion part.

5. The battery shell according to claim 1, wherein the insertion part is produced using a pultrusion process.

6. The battery shell according to claim 1, wherein the battery shell is formed using an injection-molding process or a compression-molding process.

7. The battery shell according to any claim 1, wherein an indentation has a straight line at least in some regions at a location corresponding to the insertion part.

8. The battery shell according to claim 1, wherein an indentation has the form of a groove.

9. The battery shell according to claim 1, wherein an indentation at a location corresponding to the insertion part has, at least in some regions, a plane that runs parallel to a plane of the insertion part.

10. The battery shell according to claim 1, wherein an indentation opposite the base of the battery shell runs horizontally and/or vertically, at least in some regions.

11. The battery shell according to claim 1, wherein an indentation has a transverse extension, wherein the transverse extension has a width of greater than or equal to 1 mm at its widest point and/or wherein the transverse extension has a width of less than or equal to 20 mm at its widest point.

12. The battery shell according to claim 1, wherein an indentation encloses one edge of the insertion part at least in some regions.

13. The battery shell according to claim 1, wherein an indentation on the side opposite the insertion part of the region of the battery shell receiving the insertion part has a corresponding opposite indentation.

14. The battery shell according to claim 1, wherein a first indentation on the side opposite the insertion part of the region of the battery shell receiving the insertion part has a second indentation, which is arranged offset to a position opposite the first indentation.

15. The battery shell according to claim 1, wherein an insertion part is arranged in an inner stiffening means of the battery shell, in particular is arranged in a rib.

16. The battery shell according to claim 1, wherein an insertion part is arranged in an outer stiffening means of the battery shell.

17. The battery shell according to claim 1, wherein the insert comprises a thermoplastic, a thermosetting or a metallic base material.

18. The battery shell according to claim 1, wherein the molding compound has a thermoplastic or a thermosetting base material.

19. The battery shell according to claim 1, wherein the insert has a chamfer.

20. A tool for producing the battery shell according to claim 1, wherein the tool forms an article cavity, wherein the tool comprises means for reproducibly positioning an insertion part within the article cavity, wherein the tool comprises means for introducing a molding compound into the article cavity.

21. The tool according to claim 20, wherein the tool has at least one stop, wherein the at least one stop is at least part of the means for reproducibly positioning the insertion part.

22. The tool according to claim 20, wherein the tool has at least one guide region, wherein the at least one guide region is configured to guide the insertion part at least on one side corresponding to one another via the insertion part, wherein the at least one guide region is at least part of the means for reproducibly positioning the insertion part.

23. The tool according to claim 20, wherein the means for reproducibly positioning the insert is spring-loaded.

24. A method for producing a battery shell, comprising a base and at least four side walls, wherein the battery shell has an inner side and an outer side,
wherein the battery shell is formed in hybrid design from an insertion part and a molding compound,
wherein the battery shell has at least one indentation, wherein the at least one indentation extends in a region of the battery shell formed by the molding compound, wherein one indentation has a location corresponding to the insertion part and wherein a distance from the corresponding location of the indentation to the insertion part is less than or equal to 2 mm, the method comprising, by means of an injection-molding device or a compression-molding device with a tool, forming an article cavity according to claim 20, comprising a means for reproducibly positioning an insertion part within the article cavity and a means for introducing a molding compound into the article cavity, wherein the method for producing the battery shell comprises the following steps:
a) inserting the insertion part into the article cavity;
b) inserting the molding compound into the article cavity;
c) forming the battery shell;
d) demolding the battery shell.

25. A traction battery, in particular a traction battery for a motor vehicle, comprising a battery shell comprising a base and at least four side walls, wherein the battery shell has an inner side and an outer side,
wherein the battery shell is formed in hybrid design from an insertion part and a molding compound,
wherein the battery shell has at least one indentation, wherein the at least one indentation extends in a region of the battery shell formed by the molding compound, wherein one indentation has a location corresponding to the insertion part and wherein a distance from the corresponding location of the indentation to the insertion part is less than or equal to 2 mm,
produced with a tool according to claim 20.

26. A motor vehicle comprising a battery shell comprising a base and at least four side walls, wherein the battery shell has an inner side and an outer side,
wherein the battery shell is formed in hybrid design from an insertion part and a molding compound,
wherein the battery shell has at least one indentation, wherein the at least one indentation extends in a region of the battery shell formed by the molding compound, wherein one indentation has a location corresponding to the insertion part and wherein a distance from the corresponding location of the indentation to the insertion part is less than or equal to 2 mm, produced with a tool according to claim 20.
